(19) United States
(12) Patent Application Publication
(10) Pub. No.: US 2017/0314387 A1
(43) Pub. Date: Nov. 2, 2017

(54) Apparatus and Method of Conductivity and Permeability Based on Pulsed Eddy Current

(71) Applicant: GOWell International, LLC, Houston, TX (US)

(72) Inventors: Qinshan Yang, Katy, TX (US); Yanxiang Yu, Houston, TX (US); Jinsong Zhao, Houston, TX (US)

(73) Assignee: GOWell International, LLC, Houston, TX (US)

(21) Appl. No.: 15/141,514

(22) Filed: Apr. 28, 2016

(51) Int. Cl. E21B 47/09; E21B 17/10; E21B 17/20; G01V 3/28; E21B 47/12; E21B 17/16

(52) U.S. Cl. CPC E21B 47/0905; G01V 3/28; E21B 47/122; E21B 17/1021; E21B 17/20; E21B 17/16

(57) ABSTRACT

A method and system for locating a stuck pipe. The method for locating a stuck pipe may comprise inserting an inspection device into a wellbore, transmitting an electromagnetic field, inducing an eddy current within a tube to provide an induced eddy current, recording a voltage from the induced eddy current within the tube, and analyzing tube properties from the recorded voltage. A system for locating a stuck pipe may comprise a drilling rig, a tether, and a telemetry module, where the telemetry module may comprise an accelerometer. The system may comprise a centralizing module, where the centralizing module comprises at least three arms, and an inspection device, where the inspection device comprises a memory module, a transmitter and receiver controller, and a sensor array. The sensor array may comprises a receiver and a transmitter. The system may comprise an information handling system and a service device.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

### Field of the Invention

This disclosure relates to a field for determing free pipe and stuck pipe with non-destructive detection tools. Specifically, the disclosure relates to an electromagnetic downhole tool for locating points at which a tubular secation may be stuck in a wellbore.

### Background of the Invention

Wellbores may be typically formed by boring a hole into the earth through use of a drill bit disposed at the end of a tubular string. In embodiments, the tubular string may be a series of connected drill collars. Weight may be applied to the drill string while the drill bit is rotated. Fluids may be circulated through a bore within the drill string, through the drill bit, and then back up the annular region formed between the drill string and the surrounding earth formation. The circulation of fluid in this manner may clear the bottom of the hole of cuttings, cool the bit, and circulate the cuttings back up to the surface for retrieval and inspection.

In embodiments, a wellbore depth may be in excess of thousands of feet. The upper portion of the wellbore may be lined with a string of surface casing, while intermediate portions of the wellbore may be lined with liner strings. The lowest portion of the wellbore may remain open to a surrounding formation during drilling. Without limitation, the drill string may become increasingly longer as the drill sting moves into greater depths. Wells may be non-vertical and/or diverted, which may produce a jagged and rocky path leading to the bottom of the wellbore where new drilling may take place. Due to the non-linear path through the wellbore, the drill string may become bound and/or stuck in the wellbore as it moves axially and/or rotationally. Additionally, the process of circulating fluids up the annulus within the formation may cause subterranean rock to cave into the wellbore and encase the drill string. This may cause certain areas of the drill sting to become stuck.

With the immense length of the drill string, releasing stuck pipe may be difficult. In addition, the point at which one tubular in a drill string may be stuck within another tubular and/or within the formation may be important to the operation. Without limitation, tubing that may not be stuck may be defined as “free pipe,” and tubing that may be stuck against a tubular and/or formation may be defined as “stuck pipe.” It may be desirable for the operator to obtain a more precise location of stuck pipe within the drill sting to help in freeing the stuck pipe. Consequently, there is a need for an electromagnetic tool which may be disposed down tubing to determine the location of stuck pipe and free pipe. Additionally, in downhole applications, inducing eddy current within the tubing may be non-destructive means for accurately and efficiently determining the difference between stuck pipe and free pipe.

### BRIEF SUMMARY OF SOME OF THE PREFERRED EMBODIMENTS

These and other needs in the art may be addressed in embodiments by a system and method for inducing an eddy current in tubing to locate a stuck pipe.

he method for locating a stuck pipe may comprise inserting an inspection device into a wellbore, transmitting an electromagnetic field, inducing an eddy current within a tube to provide an induced eddy current, recording a voltage from the induced eddy current within the tube, and analyzing tube properties from the recorded voltage. A system for locating a stuck pipe may comprise a drilling rig, a tether, and a telemetry module, where the telemetry module may comprise an accelerometer. The system may comprise a centralizing module, where the centralizing module comprises at least three arms, and an inspection device, where the inspection device comprises a memory module, a transmitter and receiver controller, and a sensor array. The sensor array may comprises a receiver and a transmitter. The system may comprise an information handling system and a service device. The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an embodiment of a drill rig and a wellbore;

FIG. 2 illustrates an embodiment of an inspection system;

FIG. 3 illustrates an embodiment of a sensor array; and

FIG. 4 illustrates a graph of magnetic permeability affected by pressure.

### DETAILED DESCRIPTION OF THE PREFERRED EMBODIMENTS

The present disclosure relates to embodiments of a device and method for inspecting and detecting electromagnetic properties of tubing in a downhole environment. More particularly, embodiments of a device and method may detect the changes in magnetic permeability of tubing. In embodiments, an inspection device may induce an eddy current in surrounding tubing by producing an electro-magnetic field, wherein the induced eddy current may be recorded and analyzed to determine the tubing magnetic properties. Eddy currents may be produced by a transmitter, which may be switched on and off to produce and record an induced eddy current in tubing and/or surrounding tube walls. The eddy current decay and diffusion in the tube walls may be recorded by a receiver, specifically recording voltage in embodiments, which may produce a function of the tube thickness and electromagnetic properties (e.g. metal conductivity and magnetic permeability) and the configurations of tubes.

In embodiments, an inspection device may comprise any number of partially and/or fully wound transmitters and/or receivers. Windings disposed on transmitters and/or receivers may be in any shape and may comprise any number of turns. Further, transmitters and/or receivers may be disposed and wound on a sensor array and/or multi-sensor arrays, in which the number of turns may be varied on any portion on the sensor array.

In embodiments, the electro-magnetic field may be generated by a transmitter with any suitable shape and any suitable aperture. The receiver may receive signals with any suitable shape and any suitable aperture. Without limitation, the transmitter and receiver may be disposed on any suitable system, which may be deployed within a wellbore, casing, and/or drill string to determine the magnetic permeability of tubing and/or material disposed within a wellbore.

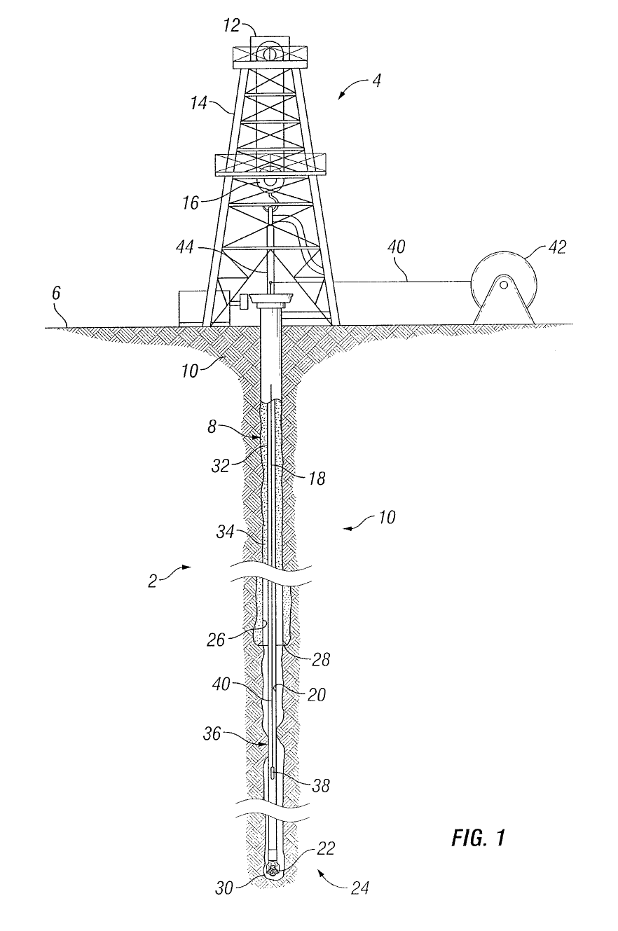

FIG. 1 illustrates a cross-sectional view of a wellbore 2 being formed. A drilling rig 4 may be disposed over an earth surface 6 to create a bore 8 into subterranean formation 10. While a land-based drilling rig may be illustrated in FIG. 1, it should be understood that the methods and apparatus of the present invention may be utilized in any drilling operations.

Drilling rig 4 may comprise a crown block 12 mounted in an upper end of a derrick 14 and a traveling block 16. Traveling block 16 may be selectively connected to the upper end of a drill string 18. Drill string 18 may comprise a plurality of joints and/or sections of drilling pipe, which may be threaded end to end. Additionally, joints of pipe may be attached to drill string 18 during drilling operation of wellbore 2.

Drill string 18 may comprise an inner bore 20 that receives circulated drilling fluid during drilling operations and a drill bit 22 attached to the lower end of drill string 18. Weight may be placed on drill bit 22 through drill string 18, which may cause drill bit 22 to act against lower rock formations 24. At about the same time, drill string 18 may rotate within bore 8. During the drilling process, drilling fluid, e.g., “mud,” may be pumped into inner bore 20 of drill string 18. The mud flows through apertures in drill bit 22 where it serves to cool and lubricate drill bit 22, and carry formation cuttings produced during the drilling operation. The mud may travel back up an annular region 26 around drill string 18, and carry the suspended cuttings back to surface 6.

As illustrated in FIG. 1, wellbore 2 may be drilled to a first depth 28, and then to a second depth 30. At first depth 28, a string of casing 32 may be placed in wellbore 2. Casing 32 may serve to maintain the integrity of formed bore 8, and isolate bore 8 from any ground water or other fluids that may be disposed in formation 10 surrounding bore 8. Casing 32 may extend to surface 6, and may be fixed in place by a column of set cement 34. Below the first depth 28, no casing or “liner” may be constructed.

Without limitation, FIG. 1 further illustrates a stuck point 36 on the walls of bore 8. Stuck point 36 may produce a situation wherein drill string 18 may no longer be rotated or axially translated within bore 8, and may be otherwise “stuck.” It should be understood, however, that stuck point 36 may be any downhole condition such as a predetermined location for measurement of tubular thickness or defect such as a hole or a crack, without departing from principles of the present disclosure.

As discussed above, it may be desirable for the operator to be able to locate the depth of stuck point 36. To this end, and in accordance with the methods of the present disclosure, an inspection device 38 may be run into wellbore 2. Inspection device 38 may be run into wellbore 2 on a tether 40. Without limitation, tether 40 may be an electric wireline, a slickline or a coiled tubing string. Inspection device 38 may operate to locate stuck point 36 along the length of drill string 18 at a measured distance from surface 6. Without limitation, detection of stuck point 36 may allow for operations to unstick the stuck pipe, which may be performed by any means known to one of ordinary skill in the art. Inspection device 38 and tether 40 may be lowered into wellbore 2 by any suitable means. Without limitation, as illustrated in FIG. 1, inspection device 38 and tether 40 may be lowered from a spool 42. Spool 42 may be brought to the drilling location by a service truck (not illustrated). Unspooling of tether 40 into wellbore 2 may be aided by a sheave wheel 44. A traveling block (not illustrated) may be used to suspend drill string 18, which may remove tension and/or torque from drill sting 18.

Tether 40 and connected inspection device 38 may move through a selected portion of wellbore 2. The selected portion may comprise the estimated depth at which stuck point 36 may exist. By moving inspection device 38 through wellbore 2, magnetic permeability data may be gathered, with the magnetic permeability data being measured as a function of wellbore depth and time.

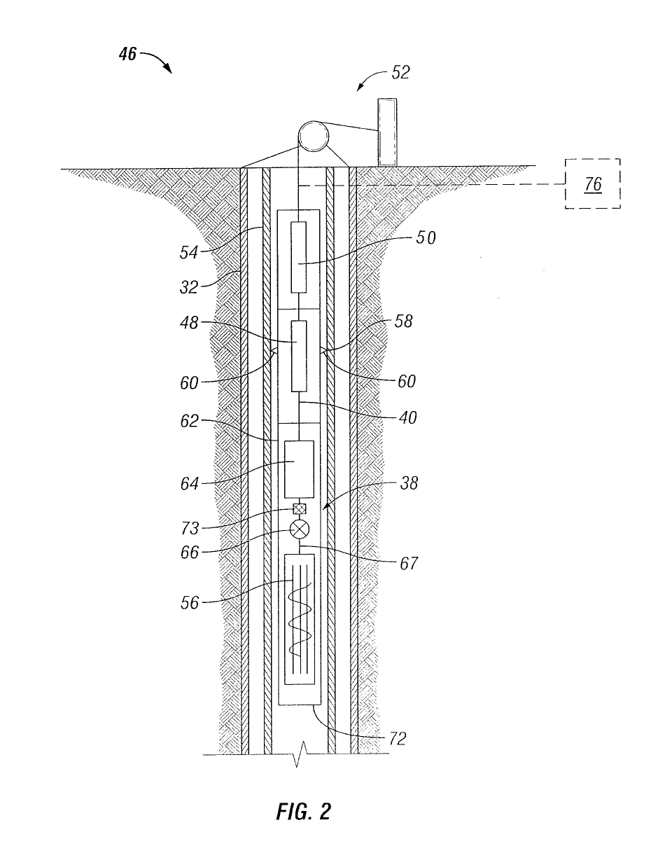

FIG. 2 illustrates an inspection system 46 comprising an inspection device 38, a centralizing module 48, a telemetry module 50, and a service device 52. In embodiments, inspection device 38 may be inserted into drill sting 18, which may comprise a plurality of tubing 54, wherein tubing 54 may be contained within casing 32. In further embodiments, not illustrated, there may be a plurality of tubing 54, wherein an inner tube may be contained by several additional tubes. In embodiments, as shown, inspection device 38 may be disposed below centralizing module 48 and telemetry module 50. In other embodiments, not illustrated, inspection device 38 may be disposed above and/or between centralizing module 48 and telemetry module 50. In embodiments, inspection device 38, centralizing module 48, and telemetry module 50 may be connected to tether 40. Tether 40 may be any suitable cable that may support inspection device 38, centralizing module 48, and telemetry module 50. A suitable cable may be steel wire, steel chain, braided wire, metal conduit, plastic conduit, ceramic conduit, and/or the like. A communication line, not illustrated, may be disposed within tether 40 and connect inspection device 38, centralizing module 48, and telemetry module 50 with service device 52. Without limitation, inspection system 46 may allow operators on the surface to review recorded data in real time from inspection device 38, centralizing module 48, and telemetry module 50.

As illustrated in FIG. 2, service device 52, as described above, may comprise a mobile platform (i.e. a truck) or stationary platform (i.e. a rig), which may be used to lower and raise inspection system 46. In embodiments, service device 52 may be attached to inspection system 46 by tether 40. Service device 52 may comprise any suitable equipment which may lower and/or raise inspection system 46 at a set or variable speed, which may be chosen by an operator. The movement of inspection system 46 may be monitored and recorded by telemetry module 50.

Telemetry module 50, as illustrated in FIG. 2, may comprise any devices and processes for making, collecting, and/or transmitting measurements. For instance, telemetry module 50 may comprise an accelerator, gyro, and the like. In embodiments, telemetry module 50 may operate to indicate where inspection system 46 may be disposed within tubing 54 and the orientation of sensor array 56, discussed below. Telemetry module 50 may be disposed at any location above, below, and/or between centralizing module 48 and inspection device 38. In embodiments, telemetry module 50 may send information through the communication line in tether 40 to a remote location such as a receiver or an operator in real time, which may allow an operator to know where inspection system 46 may be located within tubing 54. In embodiments, telemetry module 50 may be centered about laterally in tubing 54.

As illustrated in FIG. 2, centralizing module 48 may be used to position inspection device 38 and/or telemetry module 50 inside tubing 54. In embodiments, centralizing module 48 laterally positions inspection device 38 and/or telemetry module 50 at about a center of tubing 54. Centralizing module 48 may be disposed at any location above and/or below telemetry module 50 and/or inspection device 38. In embodiments, centralizing module 48 may be disposed above inspection device 38 and below telemetry module 50. Centralizing module 48 may comprise arms 58. In embodiments, there may be a plurality of arms 58 that may be disposed at any location along the exterior of centralizing module 48. Specifically, arms 58 may be disposed on the exterior of centralizing module 48. In an embodiment, as shown, at least one arm 58 may be disposed on opposing lateral sides of centralizing module 48. Additionally, there may be at least three arms 58 disposed on the outside of centralizing module 48. Arms 58 may be moveable at about the connection with centralizing module 48, which may allow the body of aim 58 to be move closer and farther away from centralizing module 48. Arms 58 may comprise any suitable material. Suitable material may be but is not limited to, stainless steel, titanium, metal, plastic, rubber, neoprene, and/or any combination thereof. In embodiments, the addition of springs 60 may further make up and/or be incorporated into centralizing module 48. Springs 60 may assist arms 58 in moving centralizing module 48 away from tubing 54, and thus inspection device 38 and telemetry module 50, to about the lateral center of tubing 54. Without limitation, centering inspection device 38 may produce more reliable and accurate voltage readings of tubing 54.

Inspection device 38, as illustrated in FIG. 2, may be located below centralizing module 48 and/or telemetry module 50. Inspection device 38 may be designed to detect defects and measure wall thickness in tubing 54 and surrounding tubing. In embodiments, inspection device 38 may be able to detect and locate transverse and longitudinal defects (both internal and external) and/or determine the deviation of the wall thickness from its nominal value thorough the interpretation of voltage data. Tubing 54 may be made of any suitable material for use in a wellbore. Suitable material may be, but is not limited to, metal, plastic, and/or any combination thereof. Additionally, any type of fluid may be contained within tubing 54 such as without limitation, water, hydrocarbons, and the like. In embodiments, there may be additional tubing which may encompass tubing 54. Inspection device 38 may comprise a housing 62, a memory module 64, a transmitter and receiver controller 66, and a sensory array 56. Housing 62 may be any suitable length in which to protect and house the components of inspection device 38. In embodiments, housing 62 may be made of any suitable material to resist corrosion and/or deterioration from a fluid. Suitable material may be, but is not limited to, titanium, stainless steel, plastic, and/or any combination thereof. Housing 62 may be any suitable length in which to properly house the components of inspection device 38. A suitable length may be about one foot to about ten feet, about four feet to about eight feet, about five feet to about eight feet, or about three feet to about six feet. Additionally, housing 62 may have any suitable width. A suitable width may be about one foot to about three feet, about one inch to about three inches, about three inches to about six inches, about four inches to about eight inches, about six inches to about one foot, or about six inches to about two feet. Housing 62 may protect memory module 64, a transmitter and receiver controller 66, and sensory array 56 from the surrounding downhole environment within tubing 54.

As illustrated in FIG. 2, memory module 64 may be disposed within inspection device 38. In embodiments, memory module 64 may store all received, recorded and measured data and may transmit the data in real time through a communication line in tether 40 to a remote location such as an operator on the surface. Memory module 64 may comprise flash chips and/or ram chips, which may be used to store data and/or buffer data communication. Additionally, memory module 64 may further comprise a transmitter, processing unit and/or a microcontroller. In embodiments, memory module 64 may be removed from inspection device 38 for further processing. Memory module 64 may be disposed within any suitable location of housing 62 such as about the top, about the bottom, or about the center of housing 62. In embodiments, memory module 64 may be in communication with transmitter and receiver controller 66 and sensor array 56 by any suitable means such as by a connection to transmitter and receiver controller 66 and sensor array 56 by a communication line 67. Memory module 64 may record voltage recordings transmitted from differential amplifier 66.

Transmitter and receiver controller 66, as illustrated in FIG. 2, may control the amplitude and phase of transmitter coils, amplifier factor, and signal acquiring period of receiver coils. Transmitter and receiver controller 66 may be pre-configured at the surface with a certain logging environment and logging case, which may be defined as static configuration, discussed below. Transmitter and receiver controller 66 may also be dynamically configured by what a receiver may record. Transmitter and receiver controller 66 may be disposed at any suitable location within housing 62. In embodiments, such disposition may be about the top, about the bottom, or about the center of housing 62.

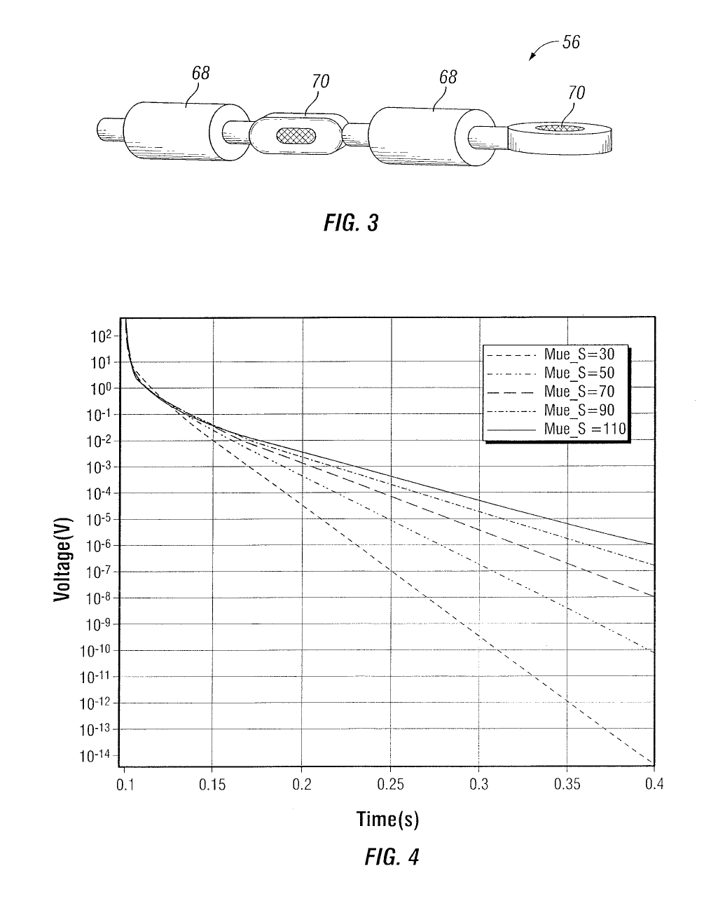

As illustrated in FIGS. 2 and 3, sensor array 56 may create an electro-magnetic field, which may induce an eddy current in surrounding tubing 54 and secondary casings (not illustrated) behind tubing 54. Sensor array 56 may comprise a transmitter 68 and a receiver 70. In examples, transmitter 68 and receiver 70 may be coaxial and disposed at a single location, for example transmitter 68 may be an outer layer and receiver 70 may be an inner layer or vice versa. Without limitation, transmitter 68 may comprise a coil and/or permanent magnet, and receiver 70 may comprise a coil and/or magnetometers. In examples, the coil may be wound around at least one ferri core. The voltage charge within tubing 54, from the induced eddy current, may be sensed and recorded by sensor array 56. In embodiments, the recorded voltage may allow identification of the characteristics of tubing 54, discussed below. Sensor array 56 may be disposed within a sensor array housing 74. Sensor array housing 74 may be composed of any suitable non-ferrous material such as plastic, ceramic, and the like. In embodiments, sensor array 56 may be disposed in a fluid within sensor array housing 74. Such disposition may prevent sensor array 56 from moving during operations and further protect sensor array 56 from subsurface pressure. The fluid may be silicone oil with different viscosity. Sensor array 56 may be disposed at any suitable location within housing 62. Such disposition may be at about the top, about the bottom, or about the center of housing 62. Additionally, there may be a plurality of sensor arrays 26 disposed throughout housing 62. As illustrated in FIG. 3, sensor array 56 may comprise at least one receiver 70 and at least one transmitter 68. In embodiments, receiver 70 may comprise any suitable material. Suitable material may be, but is not limited to, aluminum, copper, nickel, steel, and/or any combination thereof. Receiver 70 may be any suitable length. A suitable length may be, but is not limited to, about one inch to about three inches, about two inches to about four inches, about three inches to about six inches, about four inches to about eight inches, about five inches to about ten inches, or about six inches to about twelve inches. Receiver 70 may be any suitable shape. A suitable shape may be, but is not limited to, round, oval, square, triangular, polyhedral, and/or any combination thereof. Receiver 70 may sense voltage from the emitted electro-magnetic field as originally transmitted by sensor array 56. A difference in the voltages measured from tubing 54 by at least one sensor array 56 may be used to identify characteristics of tubing 54. The electro-magnetic field may be transmitted, directed, and focused within a desired area by transmitter 68.

Transmitter 68, as illustrated in FIG. 3 may be windings, which may be wound around a ferri-core, not illustrated. In embodiments, transmitter 68 may comprise any suitable material. Suitable material may be, but is not limited to, aluminum, copper, nickel, steel, and/or any combination thereof. Transmitter 70 may produce and boost an electro-magnetic field. This may increase the distance in which the electro-magnetic field may extend from sensor array 56. During operation, transmitter 68 may be energized to produce an electro-magnetic field, which may induce an eddy current in tubing 54. Transmitter 68 may then be switched off, which may allow for receiver 70 to record the voltage within tubing 54, as produced from the induced eddy current. A microprocessor and/or control unit may be used to direct current into and out of transmitter 68. Current may be used to energize transmitter 68, which may create an electro-magnetic field. Additionally, the microprocessor may be used to record and transmit the recorded voltages within receiver 70.

Detection of electromagnetic properties of tubing 54 may take place as inspection device 38 moves through tubing 54 in any direction. Travel time of inspection device 38 through a zone of interest within tubing 54 may depend on the duration of pulses and amplitude used to produce and transmit an electro-magnetic field through inspection device 38. Duration of a pulse may be set so that the signal variation between the excitation time and the “infinite” excitation time may be less than the noise constantly detected at signal level. Duration may vary based on the “electromagnetic” wall thickness of the inspected tubing 54. Electromagnetic wall thickness refers to the given conductivity and relative permeability with tubing 54 thickness. The electro-magnetic field created by the pulse may be used to induce an eddy current in tubing 54 and/or additional tubing. The induced eddy current within tubing 54 may produce an electromagnetic force voltage within tubing 54.

Receiver 70 may record the electromotive force voltage, which may be analyzed to determine the location of stuck pipe and free pipe. Electromotive force voltage may be a function of transmitter 68, receiver 70, and environmental properties. In this disclosure, environmental properties may be defined as tubing 54 and/or casing 32 properties. Tubing 54 properties and/or casing 32 properties may comprise conductivity, magnetic permeability, and/or geometry properties. Specifically, magnetic permeability may be analyzed to determine if tubing 54 may be a stuck pipe or a free pipe. For example, pressure placed upon tubing 54 may cause tubing 54 to be a stuck pipe. Additionally, the force exerted upon tubing 54, creating a stuck pipe, may also effect the electromagnetic properties of tubing 54 at the area in which the pressure may be applied. This may cause an induced eddy current to behave differently in areas of tubing 54 in which pressure may be applied to tubing 54. A specific electromagnetic property of tubing 54 that may be affected may be permeability. Permeability may be defined as the measurement of the ability of a material to support the formation of a magnetic field. Changing of the pressure applied to tubing 54 may result in a change to the permeability properties of tubing 54. FIG. 4 illustrates a chart which shows the changing of the electromagnetic properties, for example permeability, which may be studied by eddy current measurement. For example, a change in pressure may be detected by an analysis of eddy current measurements, which may be directly associated with the permeability of a material. Analysis may include but is not limited to the time domain and frequency domain of an eddy current measurement during processing. Without limitation, lower permeability may be an indication of pressure being applied to that specific area of tubing 54. In examples, it may be helpful to know the normal permeability of tubing 54 in downhole conditions, which may help an operator determine if recorded permeability may be higher and/or lower than in respect to normal permeability of tubing 54.

In embodiments, voltages of the induced magnetic field recorded by receiver 54 may be processed using information handling system 74. Referring to FIG. 2, information handling system 74 may be disposed within inspection device 38 at any location. Without limitation, information handling system 74 may also be disposed on the surface within service device 52. Processing may take place within information handling system 74 within inspection device 38 and/or on the surface in service device 52. Information handling system 74 within inspection device 38 may connect to service device 52 through waveguide 76, which may be disposed within tether 40. It is to be understood that waveguide 76 is shown as disposed in FIG. 2 for illustration purposes only as it is disposed within tether 40. Information handling system 74 may act as a data acquisition system and possibly a data processing system that analyzes signals from receiver 70, for example, to derive one or more properties of tubing 54.

Without limitation in this disclosure, information handling system 74 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, information handling system 74 may be a personal computer, a network storage device, or any other suitable device and may vary in size, shape, performance, functionality, and price. Information handling system 74 may include random access memory (RAM), one or more processing resources such as a central processing unit (CPU) or hardware or software control logic, ROM, and/or other types of nonvolatile memory. Additional components of information handling system 74 may include one or more disk drives, one or more network ports for communication with external devices as well as various input and output (I/O) devices, such as a keyboard, a mouse, and a video display. Information handling system 74 may also include one or more buses operable to transmit communications between the various hardware components.

Certain examples of the present disclosure may be implemented at least in part with non-transitory computer-readable media. For the purposes of this disclosure, non-transitory computer-readable media may include any instrumentality or aggregation of instrumentalities that may retain data and/or instructions for a period of time. Non-transitory computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such as wires, optical fibers, microwaves, radio waves, and other electromagnetic and/or optical carriers; and/or any combination of the foregoing.

The preceding description provides various embodiments of the systems and methods of use disclosed herein which may contain different method steps and alternative combinations of components. It should be understood that, although individual embodiments may be discussed herein, the present disclosure covers all combinations of the disclosed embodiments, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present embodiments are well adapted to attain the ends and advantages mentioned as well as those that are inherent therein. The particular embodiments disclosed above are illustrative only, and may be modified and practiced in different but equivalent manners apparent to those skilled in the art having the benefit of the teachings herein. Although individual embodiments are discussed, the disclosure covers all combinations of all of the embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of those embodiments. If there is any conflict in the usages of a word or term in this specification and one or more patent(s) or other documents that may be incorporated herein by reference, the definitions that are consistent with this specification should be adopted Although the present invention and its advantages have been described in detail, it should be understood that various changes, substitutions alterations may be made herein without departing from the spirit and scope of the invention as defined by the appended claims.

1. A method of locating a stuck pipe comprising:
(A) inserting an inspection device into a wellbore;
(B) transmitting an electromagnetic field;
(C) inducing an eddy current within a tube to provide an induced eddy current;
(D) recording a voltage from the induced eddy current within the tube; and
(E) analyzing tube properties from the recorded voltage.

2. The method of claim 1 further comprising:
a telemetry module, wherein the telemetry module comprises an accelerometer;
a centralizing module, wherein the centralizing module comprises at least three arms;
an inspection device, wherein the inspection device comprises a memory module, a transmitter and receiver controller, and a sensor array, wherein the sensor array comprises a receiver and a transmitter; and
a service device.

3. The method of claim 2, wherein the tube properties comprise conductivity, magnetic permeability, or geometry properties.

4. The method of claim 3, further comprising analyzing an original magnetic permeability of the tube before the tube is inserted into the wellbore and comparing the original magnetic permeability to a recorded magnetic permeability of the tube and wherein the recorded magnetic permeability is based at least in part from the recorded voltage.

5. The method of claim 3, further comprising recording a magnetic permeability at a first spot on the tube and a second spot on the tube and comparing the magnetic permeability of the first spot and the second spot.

6. The method of claim 5, wherein a lower magnetic permeability as compared to the original magnetic permeability indicates pressure being applied to the tube in the wellbore.

7. The method of claim 5, wherein a higher magnetic permeability or about the same magnetic permeability as compared to the original magnetic permeability indicates no pressure is applied to the tube.

8. A system for locating a stuck pipe comprising:
a drilling rig;
a tether;
a telemetry module, wherein the telemetry module comprises an accelerometer;
a centralizing module, wherein the centralizing module comprises at least three arms;
an inspection device, wherein the inspection device comprises a memory module, a transmitter and receiver controller, and a sensor array, wherein the sensor array comprises a receiver and a transmitter;
an information handling system; and
a service device.

9. The system of claim 8, wherein the information handling system analyzes voltages recorded by the receiver.

10. The system of claim 9, wherein the information handling system analyzes magnetic permeability of a tube before being placed downhole and after the tube is placed downhole.

11. The system of claim 10, where a lower magnetic permeability after the tube is placed downhole as compared to before the tube is placed downhole indicates pressure being applied to the tube downhole.

12. The system of claim 10, wherein a higher analyzed magnetic permeability at about the same magnetic permeability of the tube after being placed downhole as compared to before being placed downhole indicates no pressure is applied to the tube downhole.

13. The system of claim 10, wherein the transmitter broadcasts an electromagnetic field.

14. The system of claim 13, wherein the electromagnetic field induces an eddy current in a tube.

15. The system of claim 14, wherein the eddy current broadcasts a secondary electromagnetic field from the tube.

16. The system of claim 15, wherein the secondary electromagnetic field is recorded by the receiver.

17. The system of claim 8, wherein the receiver records properties of a tube comprising conductivity, magnetic permeability, and geometry properties.

18. The system of claim 8, wherein the inspection device is disposed below the centralizing module and the telemetry module.

19. The system of claim 8, wherein the inspection device comprises a housing.

20. The system of claim 8, wherein the memory module is in communication with the transmitter and receiver controller and the sensor array.
